(19) United States
(12) Patent Application Publication
(10) Pub. No.: US 2007/0119553 A1
(43) Pub. Date: May 31, 2007

(54) Replaceable screens

(76) Inventor: James V. Guffey, Ft. Myers, FL (US)

Correspondence Address: James V. Guffey, 3665 Emerald Pines Circle, Ft. Myers, FL, 33912, US

(21) Appl. No.: 11/286,402

(22) Filed: Nov. 25, 2005

(51) Int. Cl. E06B 9/24

(52) U.S. Cl. 160/371

(57) ABSTRACT

A pool or lanai screen enclosure or a screen for a window is constructed of hollow frame members having grooves at the corners of the frame members. The grooves receive splines of different cross-sections. The splines have one part of a hook and loop system attached thereto. The splines are pressed into the grooves the screens having at their edges the other part of the hook and loop fastener system attached thereto. When each part of the respective hook and loop fasteners are pressed or attached together, a complete screen between the frame members is established.

### CROSS REFERENCE TO RELATED APPLICATIONS

(none)

### STATEMENT REGARDING FED SPONSORED R & D

(none)

### BACKGROUND OF THE INVENTION

During recent hurricanes billions of dollars were lost in Florida and other coastal States to extreme forces, high winds, rain and blowing debris. Of this, a great percentage can be attributed to losses of residential pool, lanai screen cages enclosures and lost or torn window screens. As a result insurance, residential and commercial property losses are staggering and well into the billions. The building and maintenance of lanai screen enclosures is a multi-billion construction industry in the US each year. Scrap aluminum prices are at a 15 to 20 year low locally with the sudden influx of screen enclosure debris. Single panels screen replacement can cost property owners approximately $100.00 per panel. A two story cage replacement can range from $40.000 to $70.000. During the next 20 years it has been predicted by weather forecasting and government agencies that Gulf and Atlantic coastal residents can expect significant increases in the occurrence, size, strength and frequency of tropical storms and hurricanes due to a trend in rising ocean temperatures. This year's (2004) storms have devastated all effected property owners and communities and cost the insurance industry greatly because of property losses due to storm damage.

### BRIEF SUMMARY OF THE INVENTION

The inventive replaceable screen involves the use of VELCRO wherein either the loop part or the hook part of the hook and loop fastener system is attached to the conventional aluminum frame of the lanai or the pool enclosure where normally the screen material is directly attached by way of splines. The known spline now attaches a strip of the VELCRO material to the frame and the other part of the VELCRO material is attached to the edge of the screen material. The screen size is predetermined so that when the hook and loop strips are attached to each other, the screen material will tightly extend between the frame components.
1. The replaceable screen and construction system are child and accident friendly. They eliminate screen tears from accidents by “giving in” while being easily put back in place by the property owner without having to have any skills or tools.
2. The replaceable screen can be manually removed before tropical or hurricane force winds arrive and stored in a safe place. The screens can be put back in place without the purchase of new screens, materials, tools or a professional installation.
3. The replaceable screens will “blow out” or “give in” with a 60 to 80 MPH wind without damage to the material itself and reinstallation after the storm.

### BRIEF DESCRIPTION OF THE DRAWINGS

FIG. 1 is a representation of the prior art;

FIG. 2 shows hook and loop fastener attached with a spline;

FIG. 3 Is a different embodiment of attaching a spline to a vertical column;

FIG. 4 is another embodiment of attaching a spline to a vertical column;

FIG. 5 is still another embodiment of attaching a spline to a vertical column with the spline directly attached to the screen.

### DETAILED DESCRIPTION OF THE INVENTION

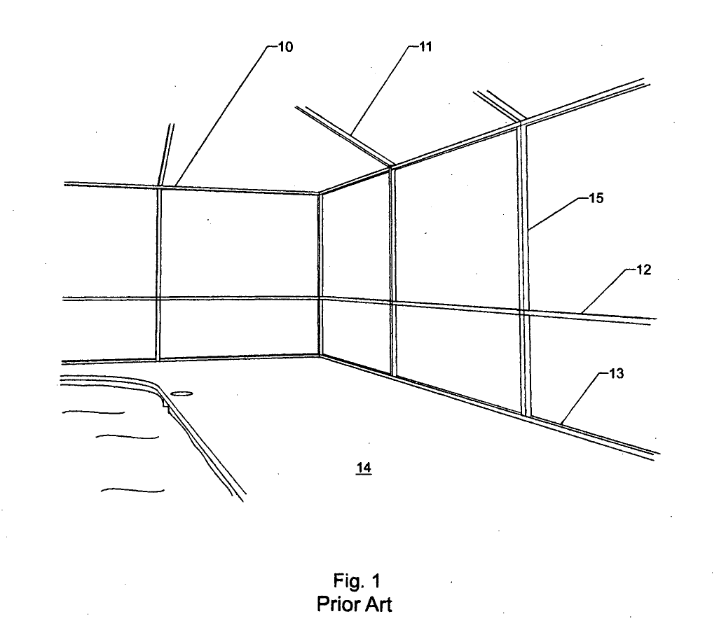

FIG. 1 is a typical prior art installation of a screen cage over a pool area. The same or similar installation can be found of a cage over a lanai. The cage consists of upper, middle and lower horizontal connecting beams 10, 12 and 13. The connecting beams are attached to the upright columns 15 which have the roof trusses 11 attached at their tops. The columns and the horizontal beams are of a hollow construction made of aluminum. Mostly they have either a square or a rectangular cross-section. They are also profiled to have longitudinal grooves therein and at their corners to receive splines therein as will be illustrated in FIGS. 2-5. At 14 is shown a deck of a swimming pool which could also be a terrace of a lanai.

FIG. 2 shows a perspective view of the construction of a vertical column 1a. The face 1 of the column faces the inside of the cage. The corners of the front face 1 have grooves 2 therein which are of different shapes depending on the configuration of the splines being used to fasten the connecting strips therein. In FIG. 2 the groove and the corresponding spline is shown having a triangular cross-section. The entrance to the grooves is somewhat restricted to retain the spline in the groove once it is forced into the groove. The triangular spline 3 has one part of a hook and loop fastening system attached thereto while the screen has the other part of the hook and loop fastening system attached thereto. When both parts of the fastening system are attached to each other, the screen material will be firmly attached to the vertical column. The fastening or attaching of the one part of the hook and loop fastening system will be explained below.

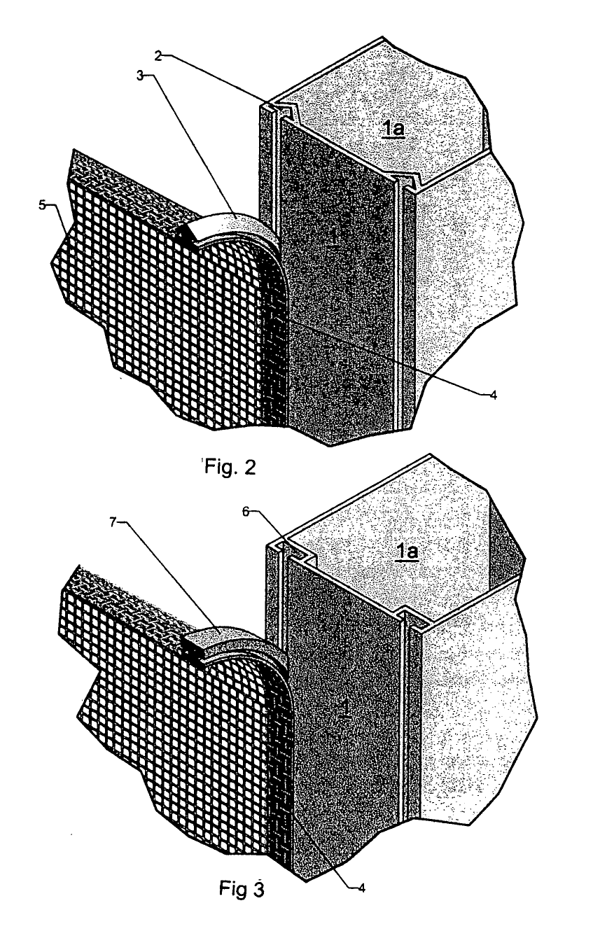

FIG. 3 shows a different embodiment of the shape of the spline material. In this embodiment, the spline material is of a rectangular shape. The same reference characters are being used as were shown in FIG. 1.

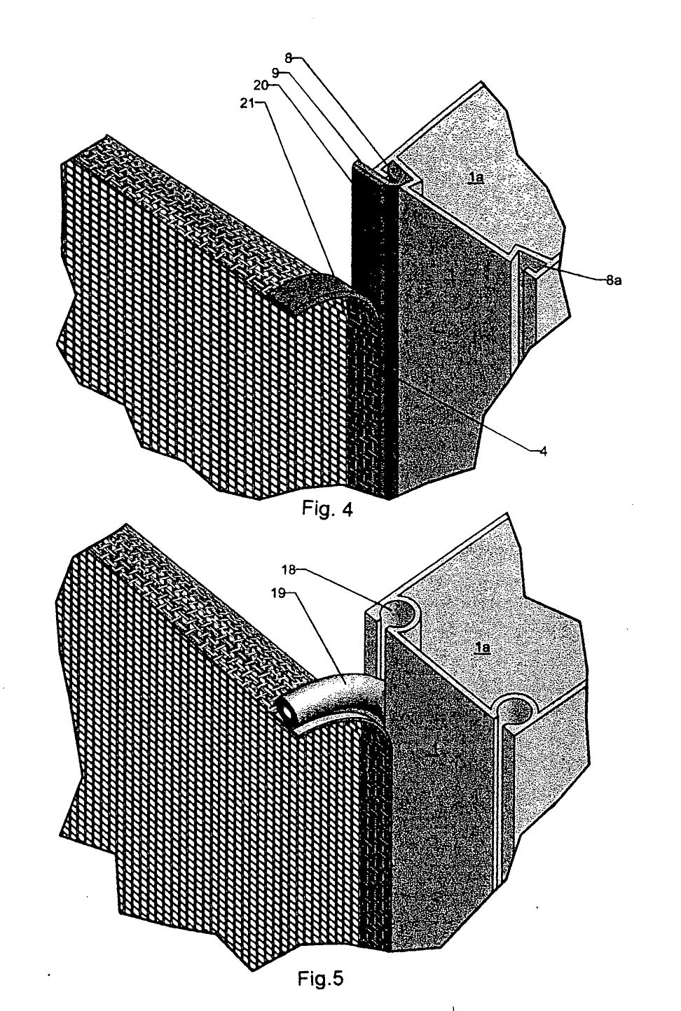

FIG. 4 shows still another shape of the spline which in this embodiment is a trapezoidal shape. This Fig. also shows the two parts of the hook and loop fastening system partly pulled away from each other to illustrate the simplicity of the inventive concept. The different cross-sectional shapes of the spline are of no important consequence. It all depends of what is available and what is preferred. Attaching the different parts of the hook and loop fasteners to the spline and to the screen, respectively, can be undertaken in many different ways. The parts could be glued, sewn or vulcanized. The ways of attaching should be weather proof because they are exposed to the elements.

FIG. 5 is still another embodiment of the spline having a round cross-section spline. The grooves 18 in each corner of the column face 1a are shown as round and the spline 19 is also shown as round. The spline 19 may be hollow to be securely heldin the groove when pressed into the same.

It should also be noted that the spline can directly be attached to the edge of the screen whereby the hook and loop fastening system can be eliminated altogether. However, the hook and loop fastening system is preferred.

What I claim is:

1. A system of applying a screen to a frame which consists of vertical hollow columns and horizontal hollow connecting beams, each of said columns and said beams having corner grooves therein for attaching said screen, said corner grooves receiving splines therein, each of said splines having one part of a hook and loop fastening system attached thereto, said screen having the other part of said hook and loop fastening system attached thereto at an edge thereof, said one part and said another part when attached to each other form a tight screen enclosure within said frame.

2. The system of claim 1, said spline has a triangular cross-section.

3. The system of claim 1, said spline has a rectangular cross-section.

4. The system of claim 1, said spline has a trapezoidal cross-section.

5. The system of claim 1, said spline has a round cross-section.

6. The system of claim 1, wherein said parts of said hook and loop system are each attached to said spline and to said screen by sewing.

7. The system of claim 1, wherein said parts of said hook and loop system are each attached to said spline and to said screen by gluing.

8. The system of claim 1, wherein said parts of said hook and loop system are each attached to said spline and to said screen by vulcanizing.

9. The system of claim 1, wherein said spline is directly attached and fastened to said screen.
